(19) United States
(12) Patent Application Publication
(10) Pub. No.: US 2015/0072192 A1
(43) Pub. Date: Mar. 12, 2015

(54) SPIRAL-WOUND CONVECTION BATTERY AND METHODS OF OPERATION

(71) Applicant: Homeland Technologies Research, LLC, Columbia, MO (US)

(72) Inventor: Galen J. Suppes, Columbia, MO (US)

(73) Assignee: HOMELAND TECHNOLOGIES RESEARCH, LLC, Columbia, MO (US)

(21) Appl. No.: 14/543,048

(22) Filed: Nov. 17, 2014

Related U.S. Application Data
(63) Continuation-in-part of application No. 13/126,971, filed on Apr. 29, 2011, now Pat. No. 8,911,893.
Application No. 13/126,971 is a continuation-in-part of application No. 13/772,068, filed on Feb. 20, 2013.
(60) Provisional application No. 61/905,878, filed on Nov. 19, 2013.

(51) Int. Cl. H01M 8/18; H01M 2/40; H01M 2/14; H01M 8/20

(52) U.S. Cl. CPC H01M 8/188; H01M 8/20; H01M 2/40; H01M 2/145
USPC 429/70; 429/144; 427/243; 264/104

(57) ABSTRACT

A salt ion battery stores consumed reagents in an electrolyte contained in a storage vessel. The electrolyte flows from electrode to counter-electrode through a flow permeable separator that has a filter support. In the most-preferred embodiment the filter support is at least partly coated with an ion exchange polymer.

### CROSS REFERENCE TO RELATED APPLICATIONS

This application is a continuation-in-part of application Ser. No. 13/126,971, filed Apr. 29, 2011, entitled “Convection Battery Configuration for Connective Carbon Matrix Electrode,” and Ser. No. 13/772,068, filed Feb. 20, 2013, entitled “Spiral-Wound Convection Battery and Methods of Operation,” and claims the benefit of provisional application Ser. No. 61/905,878, filed Nov. 19, 2013, entitled “Convection Battery and Polymer Options”.

### FIELD

The present invention relates to battery device and method of manufacturing that battery device where the battery device has improved performance and can be made from commonly available materials and hence is green chemistry. The technology is generally applicable to battery chemistries that use the same liquid electrolyte on both sides of the separator.

### BACKGROUND

The batteries, polymers, methods of simulation, methods of operation of the embodiments of this invention include the use of common salt feedstocks.

Many types of diffusion, flow, and air batteries have been disclosed and are used in practice. The convection battery is different than these because it has liquid flow directly between an electrode and its counter-electrode through a flow-permeable separator that separates the electrodes. The flow can be induced by a pump or the reciprocating action of a piston, diaphragm, or similar device.

Higher fluxes can lead to higher limiting currents when the separator area is kept constant. This reduces charge times of a battery which is a highly favorable quality.

Higher fluxes can be used to reduce surface areas of separators while keeping the limiting current the same. This leads to thicker electrodes. This result is a lower-cost battery due to reduced separator costs, reduced current collector costs, and reduced costs associated with coating the separator/membrane.

Having flow rather than diffusion allows for the use of thicker separators that have flow through paths that go through the separator. Thicker separators with flow can reduce the ability of dendrite crystals to produce a path of short circuit between electrodes.

Higher flux batteries can be used to produce an optimal combination of higher limiting currents, reduced costs, and reduced dendrite failure susceptibility as compared to batteries without convective flow of liquid electrolyte between electrodes.

Convective flow in a battery with flow-permeable separators between counter-electrodes has been demonstrated to increase limiting current/power output of that battery (same battery with flow versus without flow). A disadvantage of convective flow is that it is generally only practical for larger batteries (e.g., larger than about 1-2 kWh) since only at larger sizes does reduction in the cost of the electrodes and separators compensate for the additional cost of the pump and electrolyte circulation loop. Sonic generators can be made and operated at lower cost than pumps.

### SUMMARY

In embodiments of this invention, electrolyte flows directly between an electrode and its counter-electrode through a flow-permeable separator. A battery with this feature is referred to as a convection battery. The preferred separator is a filter that is coated with an ionic exchange polymer.

The convection battery provides superior battery performance including higher ion fluxes between counter-electrodes due to convection/flow of electrolyte between electrodes through a flow-permeable membrane. Performance advantages include (a) higher ion fluxes through the separator, (b) ability to charge with substantially lower concentrations of ions in the separator which reduces or eliminates the formation of dendrites in the separator, and (c) ability to flow liquid electrolyte through a heat exchanger to provide efficient heat exchange.

Flow may be used to control dendrite formation. One aspect of this invention is the use of flow to eliminate dendrite modes of failures in separators which can be used to reduce battery costs and increase battery density.

The salt-ions convection battery is a version of the convection battery that does not use conventional battery chemistries because the reagents are stored in the electrolyte rather than in the solid matrix of electrodes in the discharged state. The salt-ions battery is different from flow batteries in that the electrolyte flows from an electrode to its counter-electrode through a flow-permeable separator.

### BRIEF DESCRIPTION OF THE DRAWINGS

FIG. 1 is an illustration of an example convection battery embodiment with a third electrode connected in an electrical circuit to the anode (battery discharge mode) of the convection battery.

FIG. 2 is an illustration of an example convection battery embodiment with a heat exchanger in the electrolyte circulation loop.

FIG. 3 is an illustration of a salt ions battery with a storage vessel and salt crystals in the storage vessel.

### DETAILED DESCRIPTION

Embodiments of this invention include convection battery devices, configurations of those devices, and preferred methods of operating those devices with an emphasis on the salt-ions version of the convection battery. Embodiments also include methods of using the convection battery devices.

The convection battery operates with electrolyte flow between the electrode and counter-electrode through a flow-permeable separator.

In one embodiment a pump provides convection to an electrolyte (flow of electrolyte) between the electrode and counter-electrode. Table 1 provides a summary of the characteristics of various embodiments of the convection battery device 1.

TABLE 1
Summary of Defining Characteristics of
Various Convection Battery Embodiments

| | | | More |
|---|---|---|---|
| Property of Device | Units | Preferred | Preferred |
| Non-Conductive Separator | S/m | | Less than 0.001 |
| Conductivity | | | |
| Non-Conductive Separator | darcy | >0.0001 | greater than 0.001 |
| Permeability | | | |
| Electrode | darcy | >0.0001 | greater than 0.02 |
| Counter-Electrode | darcy | >0.0001 | greater than 0.02 |
| Distance Between Electrodes | mm | | 0.01 to 2 |

A medium with a permeability of 1 darcy permits a flow of 1 cm³/s of a fluid with viscosity 1 cP (1 mPa·s) under a pressure gradient of 1 atm/cm acting across an area of 1 cm². A millidarcy (md) is equal to 0.001 darcy and a microdarcy (μd) equals 0.000001 darcy. Typical values of permeability range as high as 100,000 darcy for gravel, to less than 0.01 microdarcy for granite. Sand has a permeability of approximately 1 darcy. For purposes of this invention: “permeable to flow” refers to having a permeability greater than about 0.0001 darcy and “not permeable to flow” is less than about 0.00001 darcy.

In summary, many prior-art types of diffusion, flow, and air batteries have been disclosed and are used. The convection battery is different than these because it has liquid flow directly between an electrode and its counter-electrode through a flow-permeable separator that separates them. The convection battery uses the same electrolyte in an electrode as its counter-electrode. The flow can be induced by a pump or the reciprocating action of a piston, diaphragm, or similar device. Having flow rather than diffusion allows for the use of thicker separators that have flow through paths that go through the separator. Advantages that can be realized include lower costs, higher energy density, higher power density, and novel modes of operation that add safety and reduce the ability of dendrite crystals to produce a path of short circuit between electrodes.

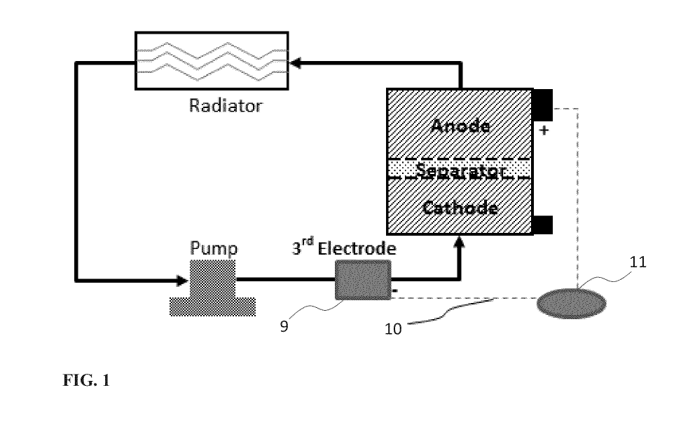

Referring to FIG. 1, in a convection battery with flow-permeable electrode, flow-permeable counter-electrode, and a flow-permeable separator; this embodiment uses the electrolyte flow to load active material (initially or as a method to regenerate an electrode) from a third electrode. The third electrode is most preferably a metallic housing that contains lithium as an active material. The regeneration includes (a) loading of desired reagent into the third electrode, (b) pumping of electrolyte through the third electrode and the electrode being loaded or regenerated, (c) completion of the electrical circuit in a method known in the art to transfer the desired material to the electrode.

For exemplary purposes, consider a Li:S convection battery in which lithium has reacted with the solvent and hence the battery is low on active material lithium. Preferably the battery is discharged to transfer all (but less than stoichiometric) lithium to the sulfur cathode. A canister of lithium is then connected into the electrolyte loop in which the pump circulates in the following manner: (a) such that there is a relatively continuous path of electrolyte from the lithium in the canister to the sulfur cathode (b) a conductive wire connects the sulfur cathode to the conductive lithium canister, and (c) additional design precautions are in place to secure a connective and conductive path from the surface of the cathode through the conductive wire and to the lithium surface with insulation from short circuit. Next, the pump is turned on whereby the lithium in the canister converts to lithium cations and transfers to the sulfur cathode surface until such time that the sulfur sites are consumed and the voltage force driving the reaction ceases. A direct current power source can be used to facilitate the transfer of lithium from the third electrode to the one of the battery electrodes as needed. Finally, the canister is removed from the circulation loop of the convection battery along with auxiliary hardware. The convection battery is charged with both the old and newly-loaded lithium transferring to the lithium anode to create a battery with a higher state of charge.

In a convection battery with flow-permeable separators between electrodes, flow of electrolyte through the electrode becomes increasingly difficult in very thin electrodes. This embodiment is on a battery where mixing/diffusion is enhanced through pressure waves (sonic waves or rapidly pulsing flow). Preferably, the battery is a stacked-cell convection battery with flow-permeable separators between electrodes which is connected with a flow pulse (sonic) generator that sends waves through the cell.

The sonic-enhanced battery most-preferred embodiment includes flow-permeable electrodes and separators (between each electrode and its counter-electrode), a flow path that would allow a reverse-flow action through both electrodes and the separator, a sonicator that generates pressure pulses in the electrolyte and is connected to the entrance of the convection battery, and a damper at the exit of the convection battery to allow pressure pulses to complete their path through the convection battery. An example frequency is 50 kHz.

In a convection battery with flow-permeable separators between electrodes, flow of electrolyte through the electrode becomes increasingly difficult in very thin electrodes. This embodiment is on a battery where mixing/diffusion is enhanced through pressure waves (sonic waves or rapidly pulsing flow). Preferably, the battery is a stacked-cell convection battery with flow-permeable separators between electrodes and their counter-electrodes which is connected with a flow pulse (sonic) generator that sends waves through the cell. Enhancement is likely and possible with separators of more-conventional design—that are not flow permeable.

The convection battery uses flow of electrolyte through the battery to enhance performance.

One type of enhanced performance is reduced mass transfer over-potentials; and specifically, reduced diffusion over-potentials. At low current fluxes when diffusion over-potentials are low without pumping of electrolyte, the preferred embodiments of this invention would not operate the pump.

Another method to enhance performance is to avoid using the battery energy to power the pump when possible. When charging a battery, it is preferred to power the pump with the same energy source as used to charge the battery.

Another method to enhance performance is to drain the battery of electrolyte when not in use. Draining the battery of electrolyte will reduce parasitic losses of stored energy. Many parasitic loss methods involve flow of ions through electrolyte; if the electrolyte is removed from the battery these routes of parasitic losses are reduced. In preferred embodiments, the draining of electrolyte and refilling of electrolyte by the pump is part of the automated control methodology.

Another method to enhance performance is to stop electrolyte flow or drain electrolyte from the battery as a means to reduce reaction rates. This can be used as a safety-shutdown in events of short circuit. Removal of electrolyte from a battery in a short-circuit situation can substantially reduce the hazards associated with the short circuit.

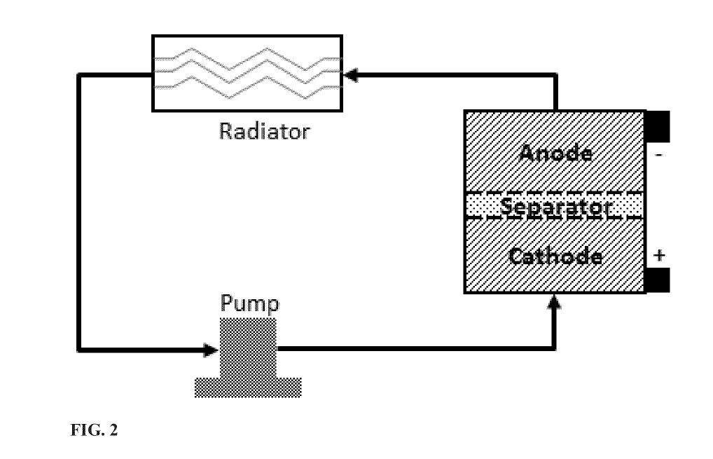

Another method to enhance performance is to operate in a manner that eliminates formation of dendrites in the separator. When lithium metal dendrites form in separators, the dendrites can cause a short circuit. The convection battery of FIG. 2 illustrates the separator between electrodes and uses tubing to connect the pump to the battery. For batteries based on lithium chemistry, the current delivered by the battery is proportional to the net amount of lithium cat ions transferred from the anode to the cathode. In a convection battery, the mass balance of the transfer of reactive ions (e.g., lithium cat ions) is substantially closed based on the volumetric flow rate of electrolyte times the absolute value of the concentration difference of lithium cat ions between the separator and tubing. This translates to the condition that the lithium cation concentration in either the electrolyte in the separator or the tubing must be less than the average concentration of lithium cat ions in the entire system. Depending upon the direction of electrolyte flow the reactive ion concentration in the separator may be less than or greater than the average concentration of reactive ion in the electrolyte. When charging a lithium battery the preferred electrolyte flow direction is that direction that leads to a lower concentration of lithium cat ions in the separator than in the tubing. This results in a lower lithium cation concentration in the separator and prevents dendrite formation in the separator.

More specifically, for a convection battery with a lithium (or lithium-plated) electrode and its counter-electrode, charging occurs with fluid sequentially through (a) the electrode to, (b) the separator to, (c) the counter-electrode to, (d) the flow channel (tubing) with pump and back to, (e) the electrode. In the most-preferred case, charging occurs with metal plating on the electrode (prior to the separator) of this flow sequence.

In an embodiment, the battery electrode composition may include a chemically active material attached to the porous carbon matrix. Suitable chemically active materials may be selected from any electrochemically active material known in the art, including but not limited to an active anodic material and an active cathodic material.

Non-limiting examples of active anodic materials include a metal selected from lithium, zinc, lead, magnesium, manganese, aluminum, and combinations thereof. Non-limiting examples of active cathodic materials include lithium oxide, zinc oxide, lead oxide, magnesium oxide, manganese oxide, aluminum oxide, cobalt oxide, vanadium oxide, titanium sulfate, molybdenum oxide, iron phosphate and combinations thereof.

In one embodiment, the amount of chemically active material attached to the porous carbon matrix is greater than 0.25 cc of chemically active material for every gram of porous carbon matrix, where the loading of the chemically active material is expressed on a gram basis of carbon material free from the active material. Using the density of the chemically active material, these specific volumes of chemically active material may be readily converted to mass fractions of chemically active material.

The intercalated graphite of existing lithium-ion batteries typically have a carbon:Li (C:Li) ratio of about 6:1 or greater. In a fully charged state, an embodiment of the convection battery has a C:Li ratio of less than 6:1, another embodiment has less than 3:1, and an exemplary embodiment less than 1.5:1. This translates to metal-on-metal loading of the carbon after the first layer of lithium is on the carbon. This C:Li ratio may be generally extended to loadings of other metals. Embodiments of this invention the prevent dendrite formation in separators can be used to advantage to decrease the C:Li ratios in lithium electrodes.

In another embodiment, the amount of chemically active material attached to the porous carbon matrix ranges from about 0.5 cc to about 4.0 cc of chemically active material for every gram of porous carbon matrix. In an exemplary embodiment, the amount of chemically active material attached to the porous carbon matrix ranges from about 0.75 cc to about 3.0 cc of chemically active material for every gram of porous carbon matrix.

### Convection Battery Device

In one embodiment, a convection battery device includes a flow-permeable anode of anode material, a flow-permeable cathode of cathode material, and a pump that provides convection of an electrolyte between the flow-permeable cathode and the flow-permeable anode. Various embodiments of the convection battery device use convective flow of electrolyte through the anode and cathode to allow large flow-permeable beds to replace prior battery designs that included multiple layers of separators and thin electrodes. The convection of the electrolyte supplements the diffusive ion transport mechanisms in the flow-permeable anode and the flow-permeable cathode, significantly enhancing overall battery performance.

A convection battery is comprised of: (a) a flow-permeable anode, (b) a flow-permeable separator, (c) a flow-permeable cathode, and (d) a method to enhance mass transfer such a pumping of electrolyte between the anode and cathode. Details of completing the exemplary battery are common and known in the art.

### Overview of Convection Battery Device

An exemplary embodiment of the convection battery device includes a flow-permeable anode, a flow-permeable cathode, and a pump. The flow-permeable anode includes an anode material and the flow-permeable cathode includes a cathode material. The anode material functions as the anode of the convection battery device, serving as an electron source during the discharging of the convection battery device and absorbing electrons during the recharging of the convection battery device. Similarly, the cathode material functions as the cathode of the convection battery device, absorbing electrons during the discharging of the convection battery device and serving as an electron source during the recharging of the convection battery device.

The pump provides convection to an electrolyte between the flow-permeable anode and the flow-permeable cathode. The convection of the electrolyte supplements the diffusive ion-exchange mechanisms used by the convection battery device during the discharging and recharging of the device, thereby enhancing the overall performance of the device. Most battery chemistries known in the art are suitable for use in the embodiments of the convection battery device.

The flow-permeable anode and the flow-permeable cathode are optionally separated by a non-conductive separator, which prevents the occurrence of electrical discharges between the flow-permeable anode and the flow-permeable cathode. In addition, the material of the separator is porous, so that an electrolyte may pass from the flow-permeable anode through the non-conductive packing and into the flow-permeable cathode.

The flow-permeable anode is encased by a conductive anode wall, which also functions as an anode current collection element to collect the electrical current from the flow-permeable anode during the discharge and recharging of the device. Similarly, the flow-permeable cathode is encased by a conductive cathode wall that also functions as a cathode current collection element to collect the electrical current from the flow-permeable cathode during the discharge and recharging of the device. The current collection elements facilitate reduced resistance in collecting electrons from the active materials in the anode and flow-permeable cathodes and respectively.

The convection battery device further includes a negative electrical terminal electrically connected to the anode current collection element, and a positive electrical terminal electrically connected to the cathode current collection element.

Materials and properties of the elements of the exemplary embodiment described above, as well as additional alternative embodiments, are described in detail below.

### Flow-Permeable Anode

The anode material included in the flow-permeable anode includes a plurality of anode granules and an active anodic material. In one embodiment, the plurality of anode granules possess material properties that are similar to the porous carbon matrix granules described above, and the active anodic material is a plurality of discrete reactive anodic granules that are dispersed among the anode granules. In this embodiment, each of the reactive anodic granules are formed into an external shape including, but not limited to a strip, a wire, a filament, a sphere, a shaving, an irregular granule, a filing, and combinations thereof.

In another embodiment, the active anodic material is attached to the anode granules using any of the methods described above. The amount of active anodic material attached to each of the anode granules is greater than 0.25 cc of active anodic material for every gram of anode granules in on embodiment, ranging from about 0.5 cc to about 4.0 cc per gram of anode granules in another embodiment, and ranging from about 0.75 cc to about 3.0 cc in an exemplary embodiment. Non-limiting examples of suitable active anodic materials include a metal selected from lithium, zinc, lead, magnesium, manganese, aluminum, and combinations thereof.

The anode material is selected to be adequately porous to allow the flow of electrolyte through the flow-permeable anode, to contain active anode materials and to allow for electrical connectivity. An illustrative example of an anode material is a mixture of lithium metal with activated carbon. Most anode materials will work provided the packed-bed material specifications are met.

The flow-permeable anode may be optionally compressed by a compressive force that is greater than 100 kPa in one embodiment, greater than about 300 kPa in another embodiment, and ranging from about 500 kPa to about 1000 kPa in an exemplary embodiment, in order to enhance the electrochemical reactivity of the flow-permeable anode. In these embodiments, the material properties of flow-permeable anode further include a compressive strength that is higher than the applied compressive force.

In an exemplary embodiment of a convective battery device having a capacity of greater than about one kW-hour, the flow-permeable anode contains greater than one kg of anode material.

### Flow-Permeable Cathode

The cathode material included in the flow-permeable cathode includes a plurality of cathode granules and an active cathodic material. In one embodiment, the plurality of cathode granules possess material properties that are similar to the porous carbon matrix granules described above, and the active cathodic material is a plurality of discrete reactive cathodic granules that are dispersed among the cathode granules. In this embodiment, each of the reactive cathodic granules are formed into an external shape including, but not limited to a strip, a wire, a filament, a sphere, a shaving, an irregular granule, a filing, and combinations thereof.

In another embodiment, the active cathodic material is attached to the cathode granules using any of the methods described above. The amount of active cathodic material attached to each of the cathode granules is greater than 0.25 cc of active cathodic material for every gram of cathode granules in on embodiment, ranging from about 0.5 cc to about 4.0 cc per gram of cathode granules in another embodiment, and ranging from about 0.75 cc to about 3.0 cc for every gram of cathode granules in an exemplary embodiment. Non-limiting examples of suitable active cathodic materials include lithium oxide, zinc oxide, lead oxide, magnesium oxide, manganese oxide, aluminum oxide, cobalt oxide, vanadium oxide, titanium sulfate, molybdenum oxide, iron phosphate and combinations thereof.

The cathode material is selected to be adequately porous to allow the flow of electrolyte through the flow-permeable cathode, to contain active cathode materials and to allow for electrical connectivity. A non-limiting example of a cathode material is iron phosphate with activated carbon. Most cathode materials will work provided the packed-bed material specifications are met.

The flow-permeable cathode may be optionally compressed by a compressive force that is greater than 100 kPa in one embodiment, greater than about 300 kPa in another embodiment, and ranging from about 500 kPa to about 1000 kPa in an exemplary embodiment, in order to enhance the electrochemical reactivity of the flow-permeable cathode. In these embodiments, the material properties of flow-permeable cathode further include a compressive strength that is higher than the applied compressive force.

In an exemplary embodiment of a convective battery device having a capacity of greater than about one kW-hour, the flow-permeable cathode contains greater than one kg of cathode material.

### Alternative Electrode

A key aspect of the convection battery is the flow path through the flow-permeable separator. The electrodes may be of essentially any proven electrode material that is made permeable to flow. Materials that generally have poor permeability may be made permeable by creating paths of travel roughly perpendicular to the surface of the separator. Drilling holes in the electrode is one option to create these paths. Forming electrode is a mold with the paths is another. Another method is to place fibers in an electrode paste during formation that can be removed later by methods such as dissolving or melting of the fibers. Preferably the paths are less than 3 mm apart at their greatest distances of separation. More preferably, the paths are between 0.3 and 1.5 mm apart in their greatest distances of separation. The preferred method for creating a flow-permeable electrode is comprised of adding a fiber of thickness between 0.005 and 0.5 mm in diameter to an electrode mix, setting the electrode mix, conversion of the fiber to a fluid, and removal of the fluid to form paths. More-preferably, the fiber is between 0.02 and 0.2 mm in diameter.

### Separator

In one embodiment, the flow-permeable anode and the flow-permeable cathode are electrically insulated from each other by the separator. In this embodiment, the separator includes a non-conductive packing material which has sufficient filtering capabilities at a depth of about 5 mm to keep the anode material and the cathode material physically separated, while allowing electrolyte to flow freely through the separator.

In various embodiments, the separator defines a separation between the surfaces. As used herein, the separation between the surfaces is defined as the length of the flow path of electrolyte from the flow-permeable anode to the flow-permeable cathode. In one embodiment, the separator defines a separation between the surfaces of greater than 0.1 mm in one embodiment, from about 2 mm to about 20 mm in another embodiment, and from about 2 mm to about 10 mm in an exemplary embodiment.

One reason that the spacing between the surfaces is important, without being bound to any particular theory, is that the space between electrodes must facilitate a flow of fluid that has a net charge. As a non-limiting example, in the zinc-alkali battery a net flow of hydroxide ions must flow from the cathode to the anode through the non-conductive separator. The flow of charges between electrodes is facilitated by counter-ions exhibiting a zero to near-zero net flow between electrodes. In a diffusion cell, the counter-ions are stationary from a bulk flow perspective. In a convection cell, the counter-ions must maintain a zero to near-zero net flow relative to the electrode entrance/exit surfaces; and to attain this, the counter-ions must undergo a diffusion mass transfer against the flow of electrolyte, assuming the counter-ions are soluble in the electrolyte. Shorter separation between the flow-permeable anode and the flow-permeable cathode imparts greater driving force for this diffusion against the flow of electrolyte which leads to higher diffusion rates and better battery performance.

In another embodiment, the separation of the surfaces created by the non-conductive packing material provides a safety margin against discharge. Illustrative examples discussed in detail below illustrate how the distance between the flow-permeable anode and the flow-permeable cathode impacts performance with reduced spaces between the electrode beds leading to improved performance.

In general, the properties of the separator are the bulk properties of that bed. In some embodiments, the non-conductive separator may have conductive particles including but not limited to steel shot so long as there is a corresponding nonconductive component including but not limited to glass wool that prevents the overall electrical connectivity of the conductive particles.

An exemplary embodiment of the separator includes non-conductive packing material having a conductivity of less than 0.001 S/m and a permeability similar to that of the anode material and cathode material. Further, in an embodiment, the non-conductive packing material should possess sufficient compressive strength to withstand the magnitudes of compressive forces that enhance the connectivity of the flow-permeable anode and the flow-permeable cathode.

Non-limiting examples of suitable materials included in the separator include crushed ceramic material, glass wool, and ion exchange media, and combinations thereof. In an embodiment stationary counter-ions are included in the separator which may be attained through use of materials including but not limited to an ion exchange material. In an exemplary embodiment, the separator includes an ion exchange media capable of at least partially countering any charge the electrolyte contains as it convects from the flow-permeable anode to the flow-permeable cathode or from the flow-permeable cathode to the flow-permeable anode.

The ion exchange media may be characterized by the density of attached ions and the strength of the sites of these ions. Both of these properties may be assessed by titration methods known in the art. Through the use of bulk density, the density of sites may be converted to units of moles per liter (molarity). The pKa measurement depends upon the solvent used. In various embodiments the pKa solvent is the electrolyte solvent in which the ion exchange material is used.

The pKa of the ion exchange media included in the separator where the separator is situated after the flow-permeable cathode ranges from about −2 to about 14 in one embodiment, from about 4-12 in another embodiment, and from about 7-12 in an exemplary embodiment. For those embodiments in which the separator is situated after the flow-permeable anode, the pKa of the ion exchange media included in the separator ranges from about −2 to about 14 in one embodiment, from about 0 to about 10 in another embodiment, and from about 0 to about 7 in an exemplary embodiment.

In an embodiment, the ion exchange media facilitates the flow of liquids with net charges. Just as the flow of these charged liquids is necessary between counter-electrodes, flow of charged liquids is also necessary within electrodes. The ion exchange properties of the flow-permeable anode and flow-permeable cathode materials are discussed in detail below.

### Electrolyte

The electrolyte has a mole fraction of ions ranging from about 0.02 to about 1.0 in one embodiment, from about 0.1 to about 0.7 in another embodiment, and from about 0.25 to about 0.5 in an exemplary embodiment. The embodiments of electrolytes include, but are not limited to various battery electrolytes known in the art. In addition, any specific battery electrolyte composition used in a convective battery device is selected to be compatible with the chemical composition of flow-permeable anode and the flow-permeable cathode.

Use of an electrolyte storage reservoir, piping, and control method that allows draining of the electrolyte into the reservoir allows for methods of reducing parasitic losses and battery shutdown as a safety feature.

### Prevention of Dendrite Formation

Dendrite formation, a major limitation for the use of metals including but not limited to lithium metal as a rechargeable material is avoided by a number of mechanisms in various embodiments. In one embodiment, a relatively large distance between the flow-permeable anode and the flow-permeable cathode limits the ability of dendrites to short-circuit the device. In another embodiment, periodic reversal of the direction of the convection of electrolyte causes any dendrite material formed to dissolve before becoming too large. In another embodiment, if dendrite needles form and break off, the packed bed configuration in which the flow-permeable beds are under significant compressive force to increase contact and conductivity within the flow-permeable beds allows for new areas of electrical contact to be established and for the lithium dendrites to once again become part of the electrode network. In still another embodiment, periodic full discharge may be used to totally dissolve any dendrite formed and to prevent the cumulative growth that may occur over repeated usage.

The preferred means to prevent dendrite short circuit during charging is to flow electrolyte in the following sequence: (a) through flow-permeable electrode where metal is deposited, (b) through flow-permeable separator, and (c) through flow-permeable counter-electrode where metal ions are release into the electrolyte from the counter-electrode. In this embodiment the lowest concentrations of metal ions are in the separator and this makes dendrite formation thermodynamically unfavorable.

### Defining Characteristics of Convection Battery Devices

Table 2 provides a final summary of the characteristics of various embodiments of the convection battery device described above.

TABLE 2
Summary of Defining Characteristics of
Various Convection Battery Embodiments

| | | | More | Most |
|---|---|---|---|---|
| Property of Device | Units | Preferred | Preferred | Preferred |
| Compressive Force on Packed- | kPa | >100 | >300 | 500-1,000 |
| Bed | | | | |
| Non-Conductive Separator | S/m | | Less than 0.001 | |
| Conductivity | | | | |
| Non-Conductive Separator | darcy | | greater than 0.02 | |
| Permeability | | | | |
| Separator Ion Exchange Bed | pKa | −2 to 14 | 4-12 | 7-12 |
| After Cathode | | | | |
| Separator Ion Exchange Bed | pKa | −2 to 14 | 0-10 | 0-7 |
| After Anode | | | | |
| Separator Ion Site | Molarity | >0.1 | 0.2-5 | 0.4-2 |
| Anode Bed Ion Exchange | pKa | −2 to 14 | 0-12 | |
| Anode Bed Ion Site | Molarity | >0.05 | 0.1-2 | 0.4-2 |
| Flow-Permeable Cathode Ion | pKa | −2 to 14 | 0-12 | |
| Exchange | | | | |
| Flow-Permeable Cathode Ion | Molarity | >0.05 | 0.1-2 | 0.4-2 |
| Site | | | | |
| Electrolyte | Mole | 0.02-1.0 | 0.1-0.7 | 0.25-0.5 |
| | fraction | | | |
| | ions | | | |
| Distance Between Electrodes | mm | >0.01 | 0.05 to 0.5 | 0.08-0.3 |
| Flow Direction | | Said distance between electrodes is for fluid | | |
| | | flow from anode to cathode (metal to oxide). | | |
| Flow Pulse | | Pulsed in Volumes equal to void volume of the | | |
| | | packed bed. | | |
| Forced Voltage Gradients and | Anode is has sections of | | Where the anode terminal | |
| Buffer Layers | different voltage where the | | is on anode section | |
| | voltage difference (anode | | further from cathode and | |
| | versus cathode) of a anode | | a resistor connects the | |
| | next to the cathode is | | anode section further | |
| | less than that for section(s) | | from the cathode to the | |
| | further from the cathode | | anode section next to the | |
| | | | cathode | |
| Isolation Check Valve, Air Gap, | | | | Double- |
| or Other Means to Connect | | | | synchronized |
| Cells in Series | | | | positive |
| | | | | displacement |
| Path Clearing Separation | | | | Flow-induced |
| | | | | Rotating |
| | | | | surrogated disc |
| Thickness of Alternating | mm | 1 to 2000 | | |
| Cathode-Electrode Sections in | | | | |
| the Same Cell | | | | |

### Battery Device with Salt Reagent Substrates

The preferred application of this embodiment is in the convection battery; however, applications include a range of electrochemical devices and devices where the electrode and its counter-electrode are separated by a non-flow-permeable separator. When a non-flow-permeable separator is used, flow between electrodes is through a path that by-passes the separator.

Through example in terms of sequence of flow, this embodiment is comprised of the following: a flow-permeable electrode, a flow-permeable separator, a flow-permeable counter-electrode, and an electrolyte recirculation loop that includes a pump for pumping the electrolyte and a storage vessel that contains both electrolyte and an electrochemical substrate. By example, sulfuric acid is an electrochemical substrate in a lead-acid battery; it is a compound that ionizes in the electrolyte and which is consumed or generated by the battery depending upon the whether the battery is being charged or discharged. General categories of electrochemical substrates are salts, acids, and bases.

Since the electrochemical substrate is consumed or generated in the battery, there is advantage in having storage capacity for the substrate outside the confines of the assembly of electrodes and separator(s). The most basic embodiment is an electrochemical device with flow permeable electrodes 1 2, an electrolyte that flows from one electrode to the other, and a storage vessel capable of storing an electrochemical substrate that is consumed and/or generated in the electrodes. This embodiment is to be distinguished from “flow batteries” in that the same electrolyte flows through both electrolytes while in flow batteries each electrode and its counter-electrode have separate electrolytes that do not mix. Also, this embodiment is to be distinguished from “flow batteries” in that the solid composition of both electrodes changes during operation.

Examples of changes in solid phase composition include but are not limited to: (a) intercalation of an alkali metal to or from a solid graphite electrode, (b) intercalation of an anion to or from a solid graphite electrode, (c) plating of a metal to/from an electrode that provides a solid support for the plating and electrode containment, and (d) a solid reactant on a solid support capable of reacting with an anion of the electrolyte.

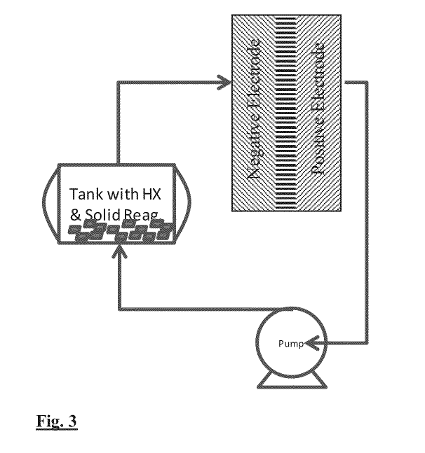

FIG. 3 illustrates a more-preferred embodiment. A more-preferred embodiment is a battery where the electrochemical substrate stored in the storage vessel exists both as a solid (typically crystalline) and ionized (in electrolyte) state where ions are able to transfer freely between the solid and ionized forms with net transfer towards a solid-liquid equilibrium between the two phases. Hereafter this will be referred to as a salt-ions convection battery.

Combined use of (a) convection battery operation that avoids dendrite mode of failure, and (b) use of external reservoir that overcomes solubility limitations allows the practical applications of many chemistries in relatively inexpensive battery. Fundamentally, it is possible to build a battery around many of the common salts. The key is to understand the nature of the problems that arise in making that battery practical, especially for cycling.

Consider, by example, the salt NaBr which would be taken apart to form compounds (e.g., sodium metal and bromine liquid) of higher Gibbs energy. One choice of these higher Gibbs energy products is Na(s) and intercalated bromine. Two problems potentially manifest in this approach. First, metal dendrites (of sodium). Second the limited solubility of NaBr in organic solvents that is stable in the presence of sodium metal. A third, potential problem, is that of mass transfer overpotential, especially at low concentrations.

On the topic of dendrites, the convection battery overcomes dendrite formation problems by first basically mixing of the electrolyte to maintain relatively constant concentration of electrolyte throughout the battery—avoiding higher levels of metal electrochemical potential in the separator which can cause dendrite formation. Operation can be in a mode where the minimum metal electrochemical potential is in the separator through choice of sequence of electrolyte flow in the convection battery.

On the topic of solubility, typically, organic solvents are used with alkali metals so as to avoid violent reactions between the solvent and the metal. A problem thus arises in that salts such as NaBr have very low solubility in the organic solvents. However, in the convection battery an exterior tank with solid NaBr in contact with the flowing organic solvent provides for a huge ability to replenish the soluble NaBr. A battery gives off heat, and so during operation the battery will be slightly warmer than the reservoir which will stop NaBr from plating out in the battery during charging. As necessary, the battery can be heated slightly or the reservoir cooled slightly to keep the vast majority of NaBr in the tank.

On the topic of mass transfer, mass transfer is less of a problem with convection of the electrolyte.

While this embodiment has been described in terms of one approach to building a battery around NaBr, the approach is generally applicable to a wide range of salts. Using the point of reference of the anode being the location for metal deposition; there are many options for the cathode. One of which is graphite for intercalation. A key point of design is that the “anion” taken into the cathode is not soluble in the liquid electrolyte. Intercalation is a means of achieving low solubility. In some cases, an S/C cathode (sulfur adsorbed on carbon) will provide for sulfur to react with the anion to form an insoluble and stable charged state. Many prospects exist including prospects for multi-electron chemistries.

Key aspects of the most preferred embodiments are: (a) metal anode where dendrite issues are overcome with the convection battery, and (b) a storage vessel of solid (or other concentration means) where a substrate is stored in a high density form. When that substrate is a salt of low Gibbs energy relative to the elements from which the salt was formed, the salt state is the discharge state of that substrate that is stored in the storage vessel.

This embodiment is a salt-ions convection battery having a discharged state comprised of a salt dissolved in a liquid electrolyte where the electrolyte flows from a flow-permeable electrode to a flow-permeable separator to a flow-permeable counter-electrode whereby a recirculation loop cycles the liquid electrolyte back to the electrode.

Preferably, the salt-ions battery has a charge state comprised of the metal of the salt in a metallic state on the positive electrode.

Preferably, the salt-ions battery has a recycle loop that includes a storage vessel capable of storing at least as much electrolyte as the rest of the battery.

Preferably, the salt-ions battery has a recycle loop that includes a pump for pumping electrolyte through the battery electrodes and recirculation loop.

### Method of Operating said Battery Device with Salt Reagent Substrates

The embodiments of this invention include both the electrochemical device as described in the previous section as well as the method of operation of the electrochemical device. Modes of operation were explicitly and implicitly described in the previous section.

Preferably, the storage vessel is at a lower temperature than the electrodes during battery use.

Preferably, the storage vessel has heat transfer fins and external fluid flow paths such that the storage vessel is both a storage vessel and a heat exchanger (the external fluid may be air). Since salt solubilities typically increase with increasing temperature, it is desirable for the storage vessel to be at a lower temperature than the electrodes which happens naturally since inefficiencies of electrochemistry produce heat in the electrodes. In the most preferred embodiment, the reservoir is 2 to 10 degrees Celsius lower in temperature than the electrodes during operation.

### Preferred Salt Embodiments

In a more-preferred embodiment of the salt-ions convection battery, the discharge state of the battery contains the reactive substrates in the form of salts (soluble) in the liquid electrolyte with optional salt crystals in a storage vessel 24. The most preferred negative electrode in the charged state is the plated metal of the salt where dendrite failure is prevented by already disclosed methods of operating the convection battery. The improvement is an anode where the negative ion of the dissolved salt reacts to form a compound that is substantially not soluble in the electrolyte and adheres to the positive electrode.

Preferably, the salt-ions convection battery includes an electrolyte containing salts of alkali metals and/or salts of rare earth metals. Most preferably, metals component of the salt has a lower molecular weight than 100; including salts such as lithium, magnesium, and zinc. Most preferably, salts for the group including e MgBr₂, LiBr, and Zn Br₂. Electrolytes are determined based on compatibility with the metal of the salts. Lithium requires organic solvents that do not react with lithium. Zinc may use aqueous-based solvents.

Preferred negative electrodes (location of metal in charged state) are highly porous activated carbon or sintered metal to which metal will plate/coat. Preferred positive electrodes are highly porous activated carbon or similar adsorbent which is effective for electrode purposes. Preferred BET surface areas of the electrodes are between 500 and 5000 m2/g with more-preferred BET surface areas of 1500 to 3500 m²/g. Preferred porosities are between 0.6 and 0.9 and more-preferred between 0.7 and 0.85.

### Electrode Column Embodiment

In the charged state of the salt-ions battery a form of the anion is deposited on the positive electrode. For example, bromide ions would produce bromine (Br₂) that adsorbs to the positive electrode. A preferred way to reduce degradation of performance due to solubility of non-ionic substrates is to place an adsorption column electrode in the flow of the electrolyte after the positive electrode. Whereas the electrode has a width that is typically greater than three times its thickness, the adsorption column electrode has a thickness (dimension in direction of flow) that is at least three times greater than its width. Methods known in chromatography science can be used to design effective adsorption column electrodes which function much like liquid chromatography columns. Functionally, the column adsorbs the non-ionic substrate where many column-volumes of electrolyte are needed before breakthrough of the non-ionic substrate.

One column could serve the discharge of several cells. Connecting the column as an electrode would allow regeneration of the column during the discharge mode. In the science, the column is described as having a L:D ratio (length:diameter) greater than 3 and is packed with a suitable adsorbent (e.g., activated carbon) as well as electrical connectivity to allow any adsorbed substrate to react during discharge.

In a salt-ions convection battery, the preferred electrolyte flow during charging is in a sequence from the negative electrode, through the flow-permeable separator, through the positive electrode, and axially (in the length direction) through an adsorption column having a length to diameter ratio rather than 3.0. Preferably, the adsorption column contains an electrically conductive adsorbent which is connected as a sequentially second positive electrode. Preferably, one adsorption column is connected in series with multiple positive electrodes.

### Dense Electrolyte Embodiment of Salt Ions Battery

When the metal substrate (charged state metal) of the salt-ions battery is compatible with water, the preferred electrolyte densities are greater than 1.05 (kg/L) and preferably greater than 1.10. The preferred means to attain these densities is to add a non-reactive salt to the water to increase the ionic nature of the electrolyte even after the substrate ions react. The preferred concentration of non-reactive salt is greater than 10% by mass of the electrolyte mixture and more-preferably greater than 25% by mass. The increased density and ionic nature reduce the solubility of bromine (Br₂).

### Separator for an Electrochemical Device

This embodiment is an improved separator that is particularly useful for the convection battery. It includes both the separator device and a method for fabricating the separator. The separator has improved capabilities.

Improved capabilities include increased strength for a separator that is not flow permeable and the ability to make flow-permeable ion exchange separators.

Applications include but are not limited to fuel cells and batteries. A specific application is as a separator between electrodes where the separator has the desired property of allowing ion flow while having high resistance to flow of free electrons.

In the convection battery, the separator between electrodes must be permeable to flow. In addition, it is highly desirable that these separators have high ion conductivities as related to its surface and/or bulk properties. Such separator materials are not, generally, commercially available.

The separators may be flow permeable or they may be non-permeable to flow. An example application for flow-permeable separators is in convection batteries. An example application of non-flow-permeable separators is in flow batteries.

Preferably, the convection battery includes an ion exchange separator comprised of an inner structure that is a porous and flow permeable filter whereby the filter is at least partially covered with an ion exchange material.

Preferably the filter is a fibrous materials such as paper, i.e., filter paper.

Preferably filter is a material known to be useful as a filter.

Preferably, the filter is a filter material that has depth in a manner to create increased flow such as corrugations (e.g., corrugated steel) that create an increase flow surface area on a device that appears overall planer. Preferably, the ion exchange material selected from known ion exchange materials used in fuel cells, batteries, and/or relevant chromatographies. Preferably, the ion exchange material which constitutes a partial or total coating on the macro-structures of filter where the coating is between 0.5 and 10000 nm in thickness (more-preferably 1-100 nm in thickness, even more preferably 1-40 nm in thickness, and most preferably 3-20 mm in thickness). Preferably, the ion exchange material coating in combination with the macro structure of the filter to create a device that retains flow permeability consistent with the preferred ranges of flow permeability of convection battery separators. Preferably, the ion exchange material coating in combination with the macro structure of the filter whereby the coating bridges the flow-permeable holes of the filter create a device that is generally not flow permeable but has large areas where ion exchange material separates the two sides of the separator in a manner that allows ion conductivity that is substantially unobstructed from the properties of the filter.

By example a fiber of 1E-5 meter (0.00001 meter) radius and a 1E-8 coating has a [volume of coating]:[volume of filter] ratio of [1.002E-10−1E-10]/[1E-10] which is 0.2% by volume %. A 10 nm coating translates to about 0.2% by volume and a 1 nm coating translates to about 0.02% by volume.

Concisely stated, the separator between electrodes and counter-electrodes is a flow-permeable separator comprising an inner structure that functionally filters electrolyte as it flows between electrodes; and an ion exchange coating on said inner structure. The ion exchange coating preferably contains more than 0.5% by mass of a metal selected from the group lithium, sodium, potassium, zinc, and magnesium and more preferably more than 2%. In this instance contains refers to a content that can be determined by mass spectroscopy of the dry ion exchange material that was first placed in contact with the battery electrolyte for more than an hour prior to drying. Preferably the separator has a filter surface area for flow through the separator greater than the cross-sectional area of the cell; and more preferably the inner structure of the separator has a corrugated filter surface.

A preferred method for synthesizing a battery electrode separator device is a method comprising: coating a filter media with a solution containing the desired coating; and evaporation of volatile components from the solution. Preferably, volatile components evaporate from the solution after the solution is coated on the filter media where evaporation can be enhanced by heat, vacuum, or other methods known in the science. Preferably, the solution is such that as the solution becomes more concentrated in the polymer or polymer-forming reagents, a higher molecular weight polymer is formed through chemical reaction.

The solutions can be prepared from a wide range of a wide range of ion exchange polymer (or oligomers) and solvents such that the ion exchange polymer is soluble in the solvent at greater than 0.001 mass percent and preferably greater than 0.01 mass percent. The primary constraint on the solvent is that it evaporates to leave the polymer coating and that it does not damage the filter media.

In general, polymers and solvents used to prepare ion exchange membranes for battery separators may be used to coat filters to be used as battery separators. In general, solutions are preferably at more dilute states than used for membrane preparation. Coating methods include but are not limited to dipping the filter support into the solution, spraying the solution onto the filter, and other methods commonly used to apply coatings. The advantage of this method is that it the permeability and strength can be better controlled through use of filter synthesis technology than what is possible with approaches to prepare flow-permeable separators directly from polymer solutions.

### Method of Synthesizing said Separator

A process for creating an ion exchange separator comprised of an inner structure that is a porous and flow permeable filter where the filter is at least partially covered with an ion exchange material whereby the process includes placing a coating of ion exchange material on the filter. Preferably, the process where the filter is dipped into a solution and allowed to dry whereby the solution consists of a polymer (or polymer-forming) material and a volatile solvent whereby the drying includes evaporation of the volatile solvent. Preferably, the process where the filter is dipped into a solution that contains a polymer-forming material and the polymer is allowed to form which is in a further explanation the polymer is formed by reaction of the polymer-forming material(s). Preferably, the process where it is not limited to dipping, but rather, includes any process of wetting the filter with a material that will form a polymer coating through any combination of physical or reaction processes. The wetting and polymer forming steps may be repeated multiple times.

The methods known in the science include physical and reaction processes for forming membranes. This invention may be used in combination with these known processes as described in the above process claim and/or in a manner resulting in the above device claim. The following is a citation and copy of such a process taken from the literature for making a membrane whereby this invention would include dipping a filter into this mixture and allowing the wetted filter to dry.

Title: Assessing the Influence of Different Cation Chemistries on Ionic Conductivity and Alkaline Stability of Anion Exchange Membranes; by Christopher G. Arges, Javier Parrondo, Graham Johnson, Athrey Nadhan and Vijay Ramani; Journal Article: J. Mater. Chem., 2012, 22, 3733-3744. The following is from that article.

Substrates used and synthesis of chloromethylated polysulfone (CMPSF) are given in the supporting information section.

PSF-TMA+Cl_, PSF-DMP+Cl_, and PSF-TMP+Cl_ films: CMPSF was dissolved in DMF. For PSF-TMA+ and PSF-TMP+ films, a 3 to 1 mole ratio of base substrate to chloromethylated sites was used for determining the amount of TMA or TMP to add to the dissolved CMPSF. The reaction was run at 30 C for 48 h. For PSF-DMP+ films, a 2 to 1 mole ratio of DMP to chloromethylated site was used for determining how much DMP to add to the dissolved CMPSF. The reaction solutions were then poured on to a glass plate placed on a leveled surface in an oven. The oven was set to 60 C and the solvent was evaporated for 12 h, leaving behind a thin film on the glass plate. The film was peeled off the glass plates using a knife and copious amounts of DI H2O. All films (in the chloride form) were ironed flat by pressing at 5,000 lbs at room temperature and then vacuum dried at 80 C for 12 h. A digital micrometre was used for recording film thickness. The CMPSF concentration and size of glass plate used for casting films controlled the thickness of the films to be prepared. An example for a 50 mm film prepared on 400-600 glass plate is: 0.8 g of CMPSF dissolved in 19 mL of DMF while following the aforementioned procedure.

Ion-exchange of membranes: Films to be characterized in the hydroxide form were ion-exchanged immediately prior to characterization. The films were immersed in 1 M KOH for 24 h, where the solution was exchanged two to three times during the 24 h period. After 24 h, the films were immersed in DI water (which was pre-treated with a bubble through nitrogen purge to eliminate any carbon dioxide that might cause carbonate/bicarbonate anion formation in the films). The DI water was exchanged several times to completely remove excess hydroxide ions. The pH of the rinse water was verified to be between 7 and 8 to ensure complete removal of hydroxide ions.

### Programming Method to Simulate the Performance of the Said Battery Device

One application of the following embodiment is the simulation (for understanding and designing) of the battery of the previous embodiments.

Finite difference methods of solving problems involving coupled dependent variables in the solution of multiple differential equations are often confronted with situations where the inter-dependent behavior of the variables variable is so complex that solution by common methods is substantially not possible. This invention is on the incorporation of a “control loop” methodology in the finite difference solution algorithm to allow solution of a wider class of problems.

This invention is generally applicable to finite difference methods that involve the solution of multiple dependent variables (especially partial differential equations); however, due to the difficulty of describing the method it will be explained in terms a particular application.

In the numerical solution of an electrode where the integral of ion generation of the entire electrode is equal to the current, a typical assumption made to assist numerical solution is that the flux of ion generation is equal throughout the electrode. Based on this assumption, the ion flux is a constant that can be calculated from the constant current (and electrode geometry) used for that solution.

For the more accurate case of non-constant current flux (e.g., flux being driven based on the differences in ion electrochemical potential between the electrolyte and the solid at each location), not only does a single constant value of current flux not work, but also, the current flux is both a function of time and space. In practice, the variable that controls the current flux is the electron potential of the solid electrode (which can be approximated as constant throughout a highly conductive electrode). For purposes of discussion, this electron potential will be referred to as the control independent variable (referred to hence forward as CIV). For a lithium ion battery anode, a decrease in the CIV (leading to an increase in electrochemical potential of lithium cation in a battery of lithium chemistry) results in an increase of ion flux throughout the anode. To meet the constant current constraint of the problem, this CIV must be increased or decreased until a value is reached that results in a total current equal to the constant current specification of the problem.

One approach (not specifically the invention of this disclosure) is to perform an optimization of the CIV at every step of time of the finite difference solution. An alternative (this invention) is to implement a P, PD, PI, or PID control strategy in the finite difference solution. The variable is the CIV, the feedback is the difference between the constant current set point and the integral of current over the electrode. Proportional control would work adequately where the step size is related to the delay time for control strategy and the step size can be made adequately small.

To implement this strategy, new variables may have to be introduced and solved in the numerical method.

### Electrolyte for Improved Operation of Convection Battery

In diffusion cell batteries, mass transfer of both the electrolyte's dissolved cation and anion occur by a combination of diffusion and migration. Typically, a pseudo-steady-state is achieved where a concentration gradient drives the mass transfer of the reacting ion while a voltage gradient “holds in place” the counter-ion.

In a convection battery cell operated at moderate to high velocity, there is a substantial absence of concentration gradients, and so, mass transfer is dominated by a combination of convection and migration.

The most common mode of operation of the convection battery is where the reacting ion is being transferred by convection which is quantified as the volumetric flow rate times the change in concentration (out minus in) of the ion in question. Higher ion fluxes are possible with the convection battery, and with higher ion fluxes is the need for migration-driven counter-ion counter-diffusion. The important artifact of this overall mode of mass transfer is that convection is so efficient in the transport of the reacting ion that it can occur effectively even at low concentrations of reacting ion in solution. However, migration is more effective with higher concentrations of the counter-ion.

Preferably the convection battery includes an electrolyte containing several salts with the objective of maximizing the concentration of ions having charges opposite that of reacting ion. It should be noted that the migration component of mass transfer (perhaps characterized as stationary-ism) can be performed by any ion in solution that has a charge opposite that of the reacting ion (referred to as counter-ions, with an s at the end).

The opportunity/advantage is that it is generally possible to create an electrolyte with higher counter-ions concentration when such an electrolyte is allowed to have relatively low reactive ion concentration; which is especially important at low solubilities. A constraint on this salt mixture is that the ions with the same charge as the reacting ion must not react (to a significant extent) in competitive reactions.

Preferably, the convection battery includes an electrolyte where the counter-ions are present in equivalents (equivalent concentration) greater than the reacting ion. Preferably, the ratio of dissolved ion equivalent of reactive ion to counter-ions is less than 0.8, more preferably less than 0.5, and most preferably between 0.01 and 0.4.

In claim form this invention is as follows: Preferably, the convection battery with includes an electrolyte where the counter-ions are present in equivalents (equivalent concentration) greater than the reacting ion. Preferably, a sub-claim is the further clarification where the ratio of dissolved ion equivalent of reactive ion to counter-ions is less than 0.8, more preferably less than 0.5, and most preferably between 0.01 and 0.4.

1. A salt ions convection battery device having a discharge state comprised of a salt dissolved in a liquid electrolyte comprising:
an anode electrode layer permeable to flow,
a cathode electrode layer permeable to flow,
a flow-permeable separator layer between said anode and cathode electrode layers,
an electrolyte storage vessel, and
a means to circulate the electrolyte in a cycle within said electrolyte storage vessel between said anode electrode layer and said cathode electrode layer through said flow-permeable separator layer.

2. The device of claim 1 further comprising a heat exchange means functionally connected to said electrolyte storage vessel to passively transfer heat from said electrolyte storage vessel to the surroundings.

3. The device of claim 2 wherein said heat exchange means is a series of conductive plates with edges connected to said electrolyte storage vessel to form cooling fins.

4. The device of claim 1 having a discharge state comprising said electrolyte storage vessel containing a mixture of salt crystals and salt dissolved in electrolyte.

5. The device of claim 1 where the dissolved salt has a metal cation of at least one metal of the group lithium, sodium, potassium, zinc, and magnesium.

6. The device of claim 1 where anode electrode layer has a porosity between 0.6 and 0.9 and a BET surface area between 500 and 5000 m2/g.

7. The device of claim 1 further comprising an adsorption column functionally located such that flow proceeds from at least one positive electrode to the adsorption column to the storage vessel.

8. The device of claim 1 further comprising an electrolyte containing a reactive salt and a non-reactive salt wherein said non-reactive salt has a concentration greater than 10% by weight in the electrolyte.

9. The devise of claim 1 wherein said electrolyte contains more than one salt having a reactive ion in common.

10. A flow-permeable separator for a convection battery comprising:
an inner structure that functionally filters electrolyte as it flows between electrodes; and
an ion exchange coating on said inner structure.

11. The separator of claim 10 whereas the ion exchange coating contains more than 0.5% by mass of a metal selected from the group lithium, sodium, potassium, zinc, and magnesium.

12. The separator of claim 10 having a filter surface area for flow through the separator greater than the cross-sectional area of the cell.

13. The separator of claim 11 where said inner structure has a corrugated filter surface.

14. A method for synthesizing a battery electrode separator device comprising:
coating a filter media with a solution containing the desired coating; and
evaporation of volatile components from the solution.

15. The method of claim 14 wherein volatile components evaporate from the solution after the solution is coated on the filter media.

16. The method of claim 15 wherein components of said solution react to form a polymer.

17. A method for creating a flow-permeable electrode comprising:
adding a fiber of thickness between 0.005 and 0.5 mm in diameter to an electrode mix;
setting the electrode mix;
converting said fiber to a fluid; and
removal of said fluid to form paths.
